(19) United States
(12) Patent Application Publication
(10) Pub. No.: US 2018/0091010 A1
(43) Pub. Date: Mar. 29, 2018

(54) ELECTRIC MOTOR FOR A VEHICLE HYBRID DRIVE SYSTEM

(71) Applicant: Schaeffler Technologies AG & Co. KG, Herzogenaurach (DE)

(72) Inventors: Stefan Mackowiak, Malsch (DE); Willi Ruder, Lahr (DE); Dierk Reitz, Baden-Baden (DE)

(73) Assignee: Schaeffler Technologies AG & Co. KG, Herzogenaurach (DE)

(21) Appl. No.: 15/562,933

(22) PCT Filed: Mar. 9, 2016
(86) PCT No.: PCT/DE2016/200126

§ 371 Date: Sep. 29, 2017

(30) Foreign Application Priority Data
Mar. 31, 2015 (DE) 10 2015 205 749.6

(51) Int. Cl. H02K 1/28; H02K 1/27; B60L 11/14; B60K 6/26

(52) U.S. Cl. CPC H02K 1/28; B60K 6/26; B60L 11/14; H02K 1/274

(57) ABSTRACT

An electric motor for a hybrid drive of a vehicle comprises a rotor and a stator. The stator surrounds the rotor and the rotor is fastened to a rotor carrier. A rotor laminated core of the rotor is connected to the rotor carrier by a tongue-and-groove connection and a transverse interference fit. To form the transverse interference fit, the rotor laminated core may have, for bracing on the rotor carrier, a smaller radius than the rotor carrier.

### CROSS-REFERENCE TO RELATED APPLICATIONS

This application is the U.S. National Phase of PCT Appln. No. PCT/DE2016/200126 filed Mar. 9, 2016, which claims priority to German Application No. DE 10 2015 205 749.6 filed Mar. 31, 2015, the entire disclosures of which are incorporated by reference herein.

### TECHNICAL FIELD

The present disclosure relates to an electric motor, in particular for a hybrid drive of a vehicle, comprising a rotor and a stator, wherein the stator surrounds the rotor and the rotor is fastened to a rotor carrier.

### BACKGROUND

In a motor vehicle with hybrid drive, the driving resistance can be overcome from two independent energy sources, such as fuel of an internal combustion engine and electrical energy from a traction battery of an electric motor, by conversion into mechanical energy. Hybrid drives are known in which the electric motor is situated at a second position in series with the internal combustion engine (P2 hybrid topology). Between the internal combustion engine and the electric motor there is arranged a separating clutch which, in the open state, permits purely electric driving and, in the closed state, transmits the torque of the internal combustion engine to the drive wheel. A further object of the separating clutch consists in starting the internal combustion engine. For this purpose, by means of a targeted increase of the torque of the electric motor and by closing the separating clutch, energy is transmitted to the stationary internal combustion engine and the latter is thus accelerated. Here, the electric motor is composed of the active parts of stator and rotor, wherein the stator surrounds the rotor, which is arranged on a rotor carrier.

For the fastening of a rotor laminated core, which forms the rotor, to the rotor carrier, it is known for the rotor laminated core to be connected to the rotor carrier in the direction of the transmission. Different methods are known for this purpose. For example, use may be made of a transverse interference fit between the rotor laminated core and the rotor carrier, a tongue-and-groove connection between the rotor laminated core and the rotor carrier, or a spline connection. Special connections by means of the transverse interference fit generate high stresses in the rotor laminated core, which must be taken into consideration in the design of the lamination, the position of the magnets and in the electromagnetic configuration. Under some circumstances, the electric motor cannot be fully utilized with regard to its power capacity, because there are geometric limitations with regard to the positioning of the magnets.

Although the use of tongue-and-groove connection reduces component stresses, it is however necessary in this case for the rotor laminated core to be additionally axially fixed in order to prevent an axial or radial migration and additional play of the rotor laminated core in a circumferential direction. A degree of radial play between rotor laminated core and rotor carrier may in this case lead to imbalances and a varying air gap, which can result in bearing damage and/or power losses of the electric motor. A degree of play in a circumferential direction can lead to changes in abutting contact in the event of traction-overrun changes, and can give rise to wear.

### SUMMARY

The present disclosure discloses an electric motor, wherein the full power capacity of the motor can be utilized and a degree of play in a circumferential direction between the rotor laminated core and the rotor carrier is reliably prevented.

According to the disclosure, a rotor laminated core of the rotor is connected to the rotor carrier by means of a tongue-and-groove connection and a transverse interference fit. Owing to the combination of the transverse interference fit with the tongue-and-groove connection, an axial and a radial degree of play of the rotor laminated core on the rotor carrier is eliminated, but without generating high stresses as a result of the transverse interference fit. The power capacity of the electric motor can thus be fully utilized.

It is advantageously the case that, to form the transverse interference fit, the circular rotor laminated core has, for bracing on the circular rotor carrier, a minimally smaller radius than the rotor carrier. The rotor laminated core, which has the relatively small radius, can be easily expanded during mounting on the rotor carrier, as a result of which said rotor laminated core bears firmly against the rotor carrier after being seated thereon. This connection is in this case configured such that, at rotational speed and under thermal influences, the rotor laminated core always maintains contact with the rotor carrier. In this way, the centering effects are maintained at all times during the operation of the electric motor.

In one embodiment, to form the transverse interference fit, the rotor laminated core has, on the side facing toward the rotor carrier, multiple local contact points for abutment against the rotor carrier. Said local contact points are distributed over the entire connecting region between rotor laminated core and rotor carrier, such that an adequately strong transverse interference fit is generated.

In one alternative embodiment, to form the transverse interference fit, the rotor laminated core bears entirely against a full circumference of the rotor carrier. In this way, the rotor laminated core bears entirely against the rotor carrier and is pressed against the rotor carrier owing to the relatively small radius.

In one embodiment, the tongue-and-groove connection is formed from a tongue out of the rotor laminated core and which faces toward the rotor carrier and which engages into an oppositely situated groove formed on the rotor carrier. In this way, freedom from play in a circumferential direction is achieved by means of the targeted positioning of the degree of play in the tongue-and-groove connection. In each case one separate tongue-and-groove connection is provided for the transmission of traction torques and overrun torques. Alternatively, the tongue-and-groove connection may however also be formed from a groove on the rotor and a tongue of the rotor carrier.

In one embodiment, for the transmission of a rotational movement from the rotor laminated core to the rotor carrier, the tongue bears laterally against the groove in a movement direction of the rotor. It is thus reliably possible to realize a play-free transmission of the traction or overrun torques from the rotor to the rotor carrier.

In one embodiment, magnet pockets are formed radially over the circumference within the rotor laminated core, in which magnet pockets there is arranged in each case one magnet. Said magnets have an operative connection to a coil which forms the stator, by the interaction of which with the rotor both the driving mode (traction torque) and the generator mode (overrun torque) can be realized.

To reduce occurring component stresses as best as possible, the local contact points of the transverse interference fit and/or the tongue-and-groove connection are arranged between two magnet pockets.

In one alternative embodiment, the local contact points of the transverse interference fit are arranged below a magnet. In this way, too, the component stress is eliminated through optimum positioning of the contact points.

The rotor carrier is advantageously in the form of a hub or a clutch. Here, the movement of the rotor is reliably transmitted by the rotor laminated core to the hub and/or the clutch.

### BRIEF DESCRIPTION OF THE DRAWINGS

Embodiments according to the present disclosure are discussed in more detail with reference to the figures, in which:

FIG. 1 shows a diagrammatic illustration of a hybrid drive,

FIG. 2 shows an exemplary embodiment of a rotor of an electric motor according to the present disclosure,

FIG. 3 shows a detail from the exemplary embodiment as per FIG. 2,

FIG. 4 shows an exemplary embodiment of the tongue-and-groove connection of the rotor of the electric motor.

### DETAILED DESCRIPTION

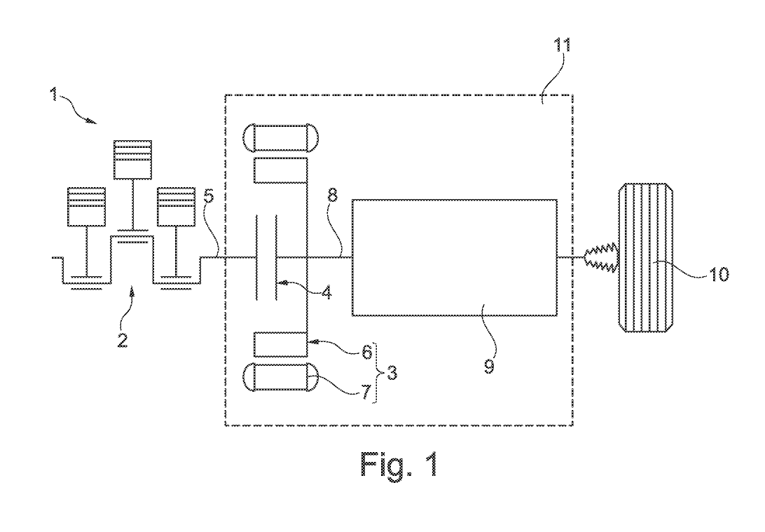

FIG. 1 shows a diagrammatic illustration of a drivetrain 1 of a hybrid vehicle.

Said drivetrain 1 comprises an internal combustion engine 2 and an electric motor 3 arranged in series therewith. Directly downstream of the internal combustion engine 2, between the internal combustion engine 2 and the electric motor 3, there is arranged a separating clutch 4. The internal combustion engine 2 and separating clutch 4 are connected to one another by means of a crankshaft 5. The electric motor 3 has a rotatable rotor 6 and a fixed stator 7. The drive output shaft 8 of the separating clutch 4 leads to a transmission 9, which comprises a coupling element (not illustrated in any more detail), for example a second clutch or a torque converter, which is arranged between the electric motor 3 and the transmission 9. The transmission 9 transmits the torque generated by the internal combustion engine 2 and/or by the electric motor 3 to the drive wheels 10 of the hybrid vehicle. Here, the electric motor 3 and the transmission 9 form a transmission system 11.

The separating clutch 4 arranged between the internal combustion engine 2 and the electric motor 3 is closed in order, while the hybrid vehicle is travelling, to start the internal combustion engine 2 by means of the torque generated by the electric motor 3 or, during boost operation, to realize travel with drive provided by the internal combustion engine 2 and electric motor 3.

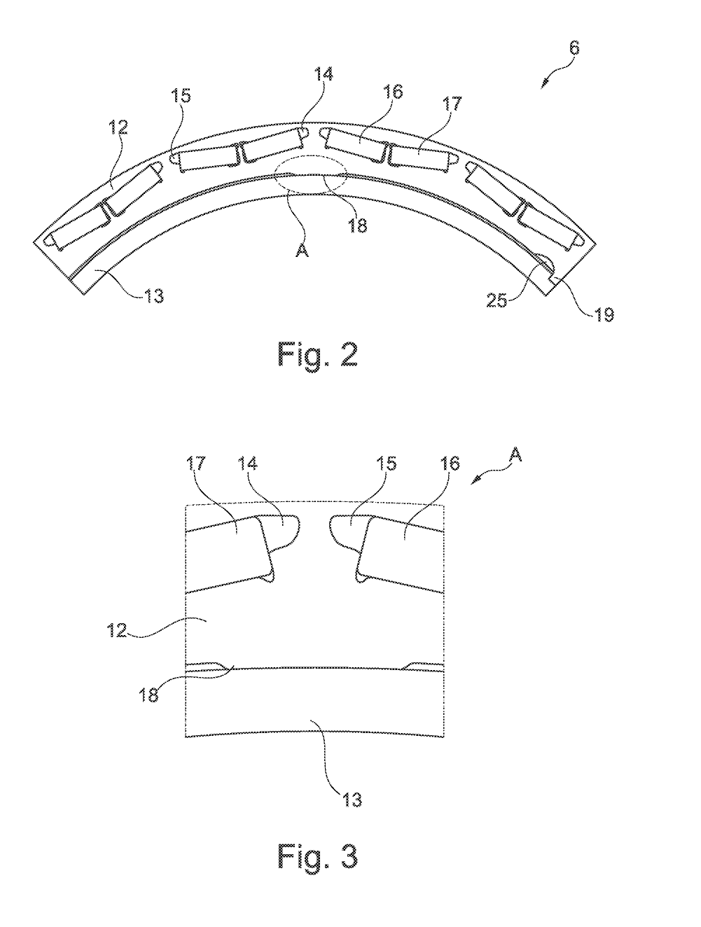

As illustrated in FIG. 2, the rotor 6 of the electric motor 3 is composed of a rotor laminated core 12 which is arranged on a hub 13, the latter serving as rotor carrier. Here, the ring-shaped rotor laminated core 12 and the circular hub 13 have a slight overlap, which means that a radius of the rotor laminated core 12 is slightly smaller than a radius of the hub 13. During assembly, the rotor laminated core 12 is expanded and clamped onto the hub 13. The transverse interference fit of the electric motor 3 is thus generated.

In the rotor laminated core 12, there are formed magnet pockets 14, 15 in which there are arranged in each case two magnets 16, 17, which are for example inclined at an obtuse angle with respect to one another. On that side of the rotor laminated core 12 which faces toward the hub 13, there are formed multiple cams 18 which are braced against the hub 13. Said cams 18 are advantageously formed at uniform intervals around the entire circumference of the rotor laminated core 12 and pressed against the hub 13 and thus form the transverse interference fit, which permits a radial and axial movement of the rotor 3.

FIG. 3 shows an enlarged detail A from FIG. 2, which shows a cam 18 formed out of the rotor laminated core 12, which cam 18 is pressed against the hub 13. It is however alternatively also possible to dispense with individual cams 18 of said type and for the rotor laminated core 12 to bear entirely against the circumference of the hub 13. Here, this transverse interference fit is configured such that, both at rotational speed and under thermal influences, the rotor laminated core 12 always maintains contact with the hub 13.

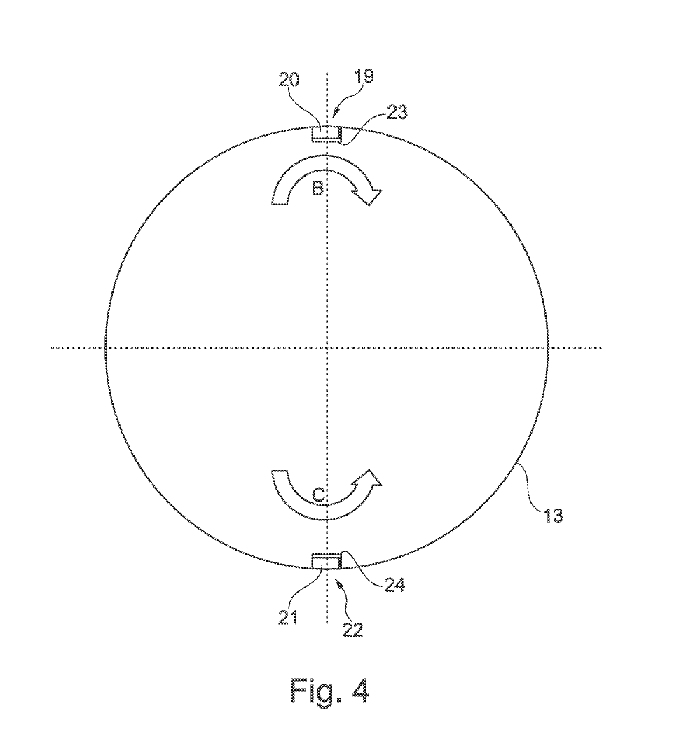

In addition to the transverse interference fit, FIG. 2 additionally shows a tongue-and-groove connection 19 between rotor laminated core 12 and hub 13, which tongue-and-groove connection is illustrated in more detail in FIG. 4. To simplify the illustration, the rotor laminated core 12 is illustrated only by the tongues 20, 21 which are formed out of the rotor laminated core 12. Here, driving operation of the electric motor 3 (arrow B) is realized by means of a first tongue-and-groove connection 19, and generator operation of the electric motor 3 (arrow C) is realized by means of a separate second tongue-and-groove connection 22. The play-free transmission of the traction torque during driving operation and of the overrun torque during generator operation is in this case realized by the tongues 20, 21 and the grooves 23, 24. Here, each tongue 20, 21 engages into the associated groove 23, 24, which grooves are formed in the hub 13. Depending on the desired transmission of the torque as traction or overrun torque, the respective tongue 20, 21 bears against the lateral region of the groove 23, 24 when the electric motor 3 is at rest, whereby a play-free transmission of the respective torque is possible.

To further reduce the stresses between rotor laminated core 12 and hub 13, a recess 25 is formed into the rotor laminated core 12 in front of each tongue-and-groove connection 19, 22, in front of the region of abutment of groove 23, 24 and tongue 20, 21 (FIG. 2).

The discussed solution thus relates to a combination composed of two tongue-and-groove connections 19, 22 and a reduced transverse interference fit for transmitting the torque from the rotor 6 to the rotor carrier 13. Radial and axial movement of the rotor 6 is in this case realized by means of local contact points in the form of cams 18 between rotor 6 and hub 13, which have a small overlap. The transmission of torque itself is realized via the respective tongue-and-groove connection 21, 22.

### LIST OF REFERENCE NUMBERS

1 Drivetrain

2 Internal combustion engine

3 Electric motor

4 Separating clutch

5 Crankshaft

6 Rotor

7 Stator

8 Drive output shaft

9 Transmission

10 Drive wheels

11 Transmission system

12 Rotor laminated core

13 Hub

14 Magnet pocket

15 Magnet pocket

16 Magnet

17 Magnet

18 Cam

19 Tongue-and-groove connection

20 Tongue

21 Tongue

22 Tongue-and-groove connection

23 Groove

24 Groove

25 Recess

1. An electric motor for a hybrid drive of a vehicle, comprising: a rotor and a stator, wherein the stator surrounds the rotor and the rotor is fastened to a rotor carrier, wherein a rotor laminated core of the rotor is connected to the rotor carrier by a tongue-and-groove connection and a transverse interference fit.

2. The electric motor as claimed in claim 1, wherein, to form the transverse interference fit, the rotor laminated core has, for bracing on the rotor carrier, a smaller radius than the rotor carrier.

3. The electric motor as claimed in claim 1, wherein, to form the transverse interference fit, the rotor laminated core has, on a side facing toward the rotor carrier, multiple local contact points for abutment against the rotor carrier.

4. The electric motor as claimed in claim 1, wherein, to form the transverse interference fit, the rotor laminated core bears entirely against a full circumference of the rotor carrier.

5. The electric motor as claimed in claim 1, wherein the tongue-and-groove connection includes a tongue formed out of the rotor laminated core that faces toward the rotor carrier and is arranged to engage with an oppositely situated groove of the rotor carrier.

6. The electric motor as claimed in claim 5, wherein, for transmission of a rotational movement from the rotor laminated core to the rotor carrier, the tongue bears laterally against the groove in a movement direction of the rotor.

7. The electric motor as claimed in claim 3, wherein magnet pockets are formed radially over a circumference of the rotor laminated core, wherein a magnet is arranged in each of the magnet pockets.

8. The electric motor as claimed in claim 7, wherein the multiple local contact points of the transverse interference fit and/or the tongue-and-groove connection are arranged between two magnet pockets.

9. The electric motor as claimed in claim 7, wherein the multiple local contact points of the transverse interference fit are arranged below the magnet.

10. The electric motor as claimed in claim 1, wherein the rotor carrier is in a form of a hub or a clutch.

11. The electric motor as claimed in claim 1, wherein the rotor laminated core is ring-shaped and the rotor carrier is circular in shape.

12. A rotor assembly for an electric motor, comprising:
a rotor core; and
a rotor carrier connected to the rotor core and including at least one groove formed therein, wherein the rotor core has at least one tongue extending in a direction toward the rotor carrier, the at least one tongue being arranged to engage the at least one groove to form a connection between the rotor core and the rotor carrier.

13. The rotor assembly as claimed in claim 12, wherein the rotor core and the rotor carrier overlap such that a radius of the rotor core is smaller than a radius of the rotor carrier.

14. The rotor assembly as claimed in claim 12, wherein a transverse interference fit is formed between the rotor core and the rotor carrier by expanding and clamping the rotor core on the rotor carrier during assembly.

15. The rotor assembly as claimed in claim 12, wherein a recess is formed in the rotor core in front of a region of abutment of the at least one groove and the at least one tongue to reduce stresses between the rotor core and the rotor carrier.

16. The rotor assembly as claimed in claim 12, wherein a plurality of cams are formed around a circumference of the rotor core on a side facing the rotor carrier, the plurality of cams being configured to be pressed against the rotor carrier to form a transverse interference fit between the rotor core and the rotor carrier.
